(19) United States
(12) Patent Application Publication
(10) Pub. No.: US 2022/0094438 A1
(43) Pub. Date: Mar. 24, 2022

(54) BI-DIRECTIONAL SINGLE FIBER TRANSMISSION USING WAVELENGTH CONVERSION

(71) Applicant: Fujitsu Limited, Kanagawa (JP)

(72) Inventors: Francois Georges Joseph Moore, Plano, TX (US); Muhammad S. Sarwar, Easton, CT (US)

(21) Appl. No.: 17/028,268

(22) Filed: Sep. 22, 2020

(51) Int. Cl. H04B 10/572; H04B 10/25

(52) U.S. Cl. CPC H04B 10/572; H04B 10/2589

(57) ABSTRACT

Disclosed methods for transmitting bi-directional optical signal traffic over a single fiber include generating, by transponders at a first location, optical signals having wavelengths within a first wavelength band, converting the generated optical signals to optical signals having wavelengths within a second wavelength band for transmission to a second location, receiving, at the first location from the second location over a single fiber cable between the first and second locations, optical signal traffic comprising optical signals in the first wavelength band, and providing the received optical traffic to the first transponders. The methods also include merging, onto the single fiber cable by a Y-cable at the first location, the optical signal traffic converted for transmission and the optical signal traffic received from the second location. The methods also include converting, at the second location, the transmitted optical signal traffic to optical signals having wavelengths within the first wavelength band.

### BACKGROUND

### Field of the Disclosure

The present disclosure relates generally to optical communication networks and, more particularly, to systems and methods for providing bi-directional single fiber transmission in optical networks using wavelength conversion.

### Description of the Related Art

Telecommunications systems, cable television systems and data communication networks use optical networks to rapidly convey large amounts of information between remote points. In an optical network, information is conveyed in the form of optical signals through optical fibers. Optical fibers may comprise thin strands of glass capable of communicating the signals over long distances. Optical networks often employ modulation schemes to convey information in the optical signals over the optical fibers. Such modulation schemes may include phase-shift keying (PSK), frequency-shift keying (FSK), amplitude-shift keying (ASK), and quadrature amplitude modulation (QAM).

Optical networks may also include various optical elements, such as amplifiers, dispersion compensators, multiplexer/demultiplexer filters, wavelength selective switches (WSS), optical switches, couplers, etc. to perform various operations within the network. Optical networks may also include various network elements, such as amplifiers, dispersion compensators, multiplexer/demultiplexer filters, wavelength selective switches, couplers, etc. configured to perform various operations within the network.

In some optical networks, network resource utilization in optical networks may be limited due to spectral slot fragmentation. In some cases, fiber capacity utilization may be increased through the use of recoloring elements, which are operable to shift individual optical channels to different wavelengths. For example, an optoelectronic wavelength converter, such as an optical-electrical-optical regenerator, converts a received optical signal to an electrical signal and then converts the electrical signal to an optical signal at a different targeted wavelength. Some all-optical wavelength shifters may be used to shift individual optical channels by a given amount.

### SUMMARY

In one aspect, a system for bi-directional single fiber transmission using wavelength conversion is disclosed. The system includes a fiber cable between a first location and a second location, a first optical wavelength converter at the first location configured to convert optical signals having wavelengths within a first one of multiple predefined optical wavelength bands to optical signals having wavelengths within a second one of the multiple predefined optical wavelength bands, and a first Y-cable at the first location coupled to the fiber cable and configured to merge first optical signal traffic comprising optical signals in the first predefined optical wavelength band with second optical signal traffic comprising optical signals in the second predefined optical wavelength band for transmission between the first location and the second location over the fiber cable, the first optical signal traffic being received at the first location from the second location, the second optical signal traffic being transmitted from the first location to the second location. The system also includes a first collection of transponders at the first location configured to generate optical signals in the first predefined optical wavelength band, to route the generated optical signals to the first optical wavelength convertor to produce the second optical signal traffic, and to receive the optical signals of the first optical signal traffic.

In any of the disclosed embodiments, the first optical signal traffic may include a first wideband optical signal in which multiple optical signals having wavelengths within the first predefined optical wavelength band are combined using wavelength division multiplexing for transmission over the fiber cable in respective channels, and the second optical signal traffic may include a second wideband optical signal in which multiple optical signals having wavelengths within the second predefined optical wavelength band are combined using wavelength division multiplexing for transmission over the fiber cable in respective channels.

In any of the disclosed embodiments, the system may further include a second optical wavelength converter at the second location configured to convert optical signals having wavelengths within the second predefined optical wavelength band to optical signals having wavelengths within the first predefined optical wavelength band, a second Y-cable at the second location coupled to the fiber cable and configured to merge the first optical signal traffic comprising optical signals in the first predefined optical wavelength band with the second optical signal traffic comprising optical signals in the second predefined optical wavelength band for transmission between the first location and the second location over the fiber cable, the first optical signal traffic being transmitted from the second location to the first location, the second optical signal traffic being received at the second location from the first location and to route the second optical signal traffic to the second optical wavelength convertor to produce converted optical signals representing the second optical signal traffic and having wavelengths within the first predefined optical wavelength band, and a second collection of transponders at the second location configured to generate the first optical signal traffic and to receive the converted optical signals representing the second optical signal traffic.

In another aspect, a method for transmitting bi-directional optical signal traffic over a single fiber is disclosed. The method includes generating, by a first collection of transponders at a first location, optical signals having wavelengths within a first one of multiple predefined optical wavelength bands, providing the generated optical signals to a first optical wavelength convertor at the first location, the first optical wavelength converter configured to convert optical signals having wavelengths within the first predefined optical wavelength band to optical signals having wavelengths within a second one of the multiple predefined optical wavelength bands, receiving, by a first Y-cable at the first location coupled to a fiber cable between the first location and a second location, first optical signal traffic comprising optical signals in the first predefined optical wavelength band, converting, by the first optical wavelength converter, the generated signals to produce second optical signal traffic having wavelengths within the second predefined optical wavelength band, providing the first optical traffic to the first collection of transponders, and merging, by the first Y-cable for transmission between the first location and the second location over the fiber cable, the first optical signal traffic and the second optical signal traffic, the first optical signal traffic being received at the first location from the second location, the second optical signal traffic being transmitted from the first location to the second location.

In any of the disclosed embodiments, the method may further include combining, at the second location using wavelength division multiplexing, multiple optical signals having wavelengths within the first predefined optical wavelength band to generate the first optical signal traffic, transmitting the first optical signal traffic from the second location to the first location in respective optical channels over the fiber cable, combining, at the first location using wavelength division multiplexing, multiple optical signals having wavelengths within the second predefined optical wavelength band to generate the second optical signal traffic, and transmitting the second optical signal traffic from the first location to the second location in respective optical channels over the fiber cable.

In any of the disclosed embodiments, the method may further include generating, by a second collection of transponders at the second location, the first optical signal traffic, receiving, by a second Y-cable at the second location coupled to the fiber cable, the second optical signal traffic, providing the second optical signal traffic to a second optical wavelength convertor at the second location, the second optical wavelength converter configured to convert optical signals having wavelengths within the second predefined optical wavelength band to optical signals having wavelengths within the first predefined optical wavelength band, converting, by the second optical wavelength converter, the second optical signal traffic to converted optical signals having wavelengths in the first predefined optical wavelength band, providing the converted optical signals to the second collection of transponders, and merging, by the second Y-cable for transmission between the first location and the second location over the fiber cable, the first optical signal traffic and the second optical signal traffic, the first optical signal traffic being transmitted from the second location to the first location, the second optical signal traffic being received at the second location from the first location.

In any of the disclosed embodiments, each transponder in the first collection of transponders may be configured to generate and receive optical signals having a respective one of the wavelengths within the first predefined optical wavelength band.

In any of the disclosed embodiments, the first optical wavelength converter may include a nonlinear medium that converts all wavelengths within the first predefined optical wavelength band to respective wavelengths within the second predefined optical wavelength band.

In any of the disclosed embodiments, each transponder in the second collection of transponders may be configured to generate and receive optical signals having a respective one of the wavelengths within the first predefined optical wavelength band.

In any of the disclosed embodiments, the second optical wavelength converter may include a nonlinear medium that converts all wavelengths within the second predefined optical wavelength band to respective wavelengths within the first predefined optical wavelength band.

In any of the disclosed embodiments, the multiple predefined optical wavelength bands comprise two or more of the C-Band, comprising wavelengths between 1530 and 1565 nanometers, the L-Band, comprising wavelengths between 1565 and 1625 nanometers, and the S-Band, comprising wavelengths between 1460 and 1530 nanometers.

In any of the disclosed embodiments, the first optical signal traffic may include optical signals having wavelengths within the C-Band and the second optical signal traffic may include optical signals having wavelengths within the L-Band or within the S-Band.

In any of the disclosed embodiments, the first optical signal traffic may include optical signals having wavelengths within the L-Band, and the second optical signal traffic may include optical signals having wavelengths within the C-Band.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating selected elements of an embodiment of an optical network;

FIG. 2A is a block diagram illustrating selected elements of an optical network carrying bi-directional traffic over two fiber cables;

FIG. 2B is a block diagram illustrating selected elements of an optical network carrying bi-directional traffic on a single fiber;

FIG. 3A is a graph illustrating five standard predefined optical wavelength bands;

FIG. 3B is a block diagram illustrating selected elements of an embodiment of an optical wavelength converter;

FIG. 3C illustrates an example wavelength converter device, in accordance with some embodiments;

FIG. 4 is a block diagram illustrating selected elements of an optical network including a single fiber cable between a pair of locations, in accordance with some embodiments;

FIG. 5A is a block diagram illustrating a wiring diagram for selected elements of an optical network at a first location, in accordance with some embodiments;

FIG. 5B is a block diagram illustrating a wiring diagram for selected elements of an optical network at a second location, in accordance with some embodiments;

FIG. 6 illustrates an example wavelength conversion, in accordance with some embodiments;

FIG. 7A is a flow chart of selected elements of a method for providing bi-directional single fiber transmission in optical networks using wavelength conversion from the perspective of a first location, in accordance with some embodiments; and

FIG. 7B is a flow chart of selected elements of a method for providing bi-directional single fiber transmission in optical networks using wavelength conversion from the perspective of a second location, in accordance with some embodiments.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

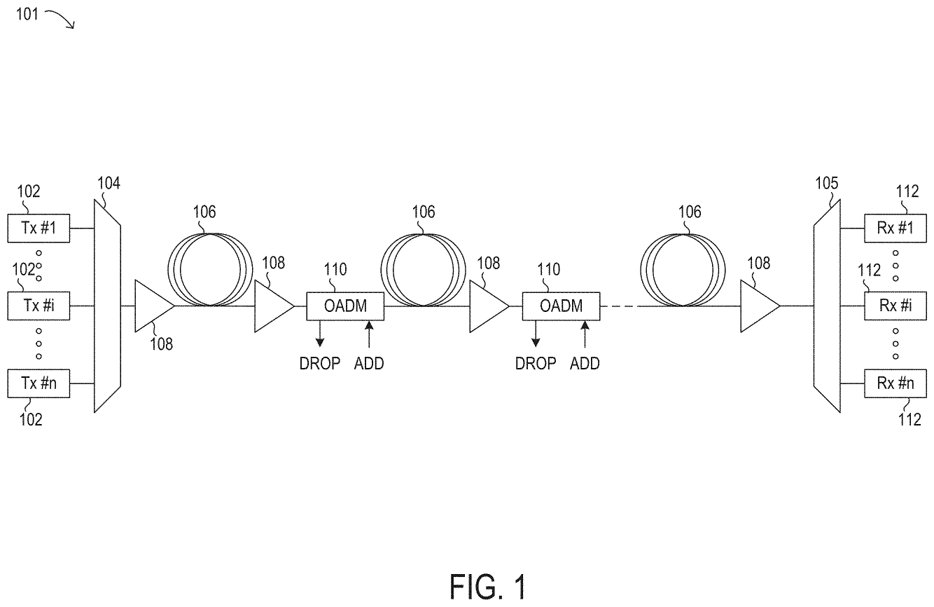

Referring now to the drawings, FIG. 1 illustrates an example embodiment of optical network 101, which may represent an optical communication system. Optical network 101 may include one or more optical fibers 106 to transport one or more optical signals communicated by components of optical network 101. The network elements of optical network 101, coupled together by fibers 106, may comprise one or more transmitters 102, one or more multiplexers (MUX) 104, one or more optical amplifiers 108, one or more optical add/drop multiplexers (OADM) 110, one or more demultiplexers (DEMUX) 105, and one or more receivers 112.

Optical network 101 may comprise a point-to-point optical network with terminal nodes, a ring optical network, a mesh optical network, or any other suitable optical network or combination of optical networks. Optical network 101 may be used in a short-haul metropolitan network, a long-haul inter-city network, or any other suitable network or combination of networks. The capacity of optical network 101 may include, for example, 100 Gbit/s, 400 Gbit/s, or 1 Terabit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a Single-Mode Fiber (SMF), Enhanced Large Effective Area Fiber (E-LEAF), or TrueWave® Reduced Slope (TW-RS) fiber.

Optical network 101 may include devices to transmit optical signals over optical fibers 106. Information may be transmitted and received through optical network 101 by modulation of one or more wavelengths of light to encode the information on the wavelength. In optical networking, a wavelength of light may also be referred to as a channel that is included in an optical signal. Each channel may carry a certain amount of information through optical network 101.

To increase the information capacity and transport capabilities of optical network 101, multiple signals transmitted at multiple channels may be combined into a single wideband optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit rate of solely one wavelength. With more bandwidth, optical networks are capable of transmitting greater amounts of information. Optical network 101 may transmit disparate channels using WDM or some other suitable multi-channel multiplexing technique, and to amplify the multi-channel signal.

Optical network 101 may include one or more optical transmitters (Tx) 102 to transmit optical signals through optical network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information contained in the electrical signals onto a beam of light produced by the laser at a particular wavelength and transmit the beam for carrying the signal throughout optical network 101.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical network 101. Optical amplifiers 108 may be positioned before or after certain lengths of fiber 106. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of an optical pump to excite the atoms of the doped portion of the optical fiber, which increases the intensity of the optical signal. For example, in some optical networks, each of optical amplifiers 108 may comprise an erbium-doped fiber amplifier (EDFA).

OADMs 110 may be coupled to optical network 101 via fibers 106. OADMs 110 comprise an add/drop module, which may include a system, apparatus or device to add and drop optical signals (for example at individual wavelengths) from fibers 106. After passing through an OADM 110, an optical signal may travel along fibers 106 directly to a destination, or the signal may be passed through one or more additional OADMs 110 and optical amplifiers 108 before reaching a destination.

In certain embodiments of optical network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) or a multicast switch (MCS) that may be included in a ROADM.

As shown in FIG. 1, optical network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical network 101 may transmit and carry a ninety-six (96) channel DWDM signal. Demultiplexer 105 may divide the single, ninety-six channel DWDM signal into ninety-six separate signals according to the ninety-six different channels. It will be understood that different numbers of channels or subcarriers may be transmitted and demultiplexed in optical transport network 101, in various embodiments.

In FIG. 1, optical network 101 may also include receivers 112 coupled to demultiplexer 105. Each receiver 112 may receive optical signals transmitted at a particular wavelength or channel and may process the optical signals to obtain (e.g., demodulate) the information (i.e., data) that the optical signals contain. Accordingly, network 101 may include at least one receiver 112 for every channel of the network.

Optical networks, such as optical network 101 in FIG. 1, may employ modulation techniques to convey information in the optical signals over the optical fibers. Such modulation schemes may include phase-shift keying (PSK), frequency-shift keying (FSK), amplitude-shift keying (ASK), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

Additionally, polarization division multiplexing (PDM) technology may enable achieving a greater bit rate for information transmission. PDM transmission comprises independently modulating information onto different polarization components of an optical signal associated with a channel. In this manner, each polarization component may carry a separate signal simultaneously with other polarization components, thereby enabling the bit rate to be increased according to the number of individual polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In an optical network, such as optical network 101 in FIG. 1, it is typical to refer to a management plane, a control plane, and a transport plane (sometimes called the physical layer). A central management host (not shown) may reside in the management plane and may configure and supervise the components of the control plane. The management plane includes ultimate control over all transport plane and control plane entities (e.g., network elements). As an example, the management plane may consist of a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, and an operational support system (OSS) which handles network-wide operations.

Modifications, additions or omissions may be made to optical network 101 without departing from the scope of the disclosure. For example, optical network 101 may include more or fewer elements than those depicted in FIG. 1. Also, as mentioned above, although depicted as a point-to-point network, optical network 101 may comprise any suitable network topology for transmitting optical signals such as a ring, a mesh, or a hierarchical network topology.

Traditional optical fiber networks in metro, regional, and long-haul applications typically use separate fibers for the transmit and receive directions. Furthermore, because single fiber transmission is only possible if individual directions are transmitted over different optical wavelength bands and existing transponders are configured to transmit and receive optical signals over the same optical wavelength band, existing systems do not support DWDM technology for transmitting bi-directional traffic over a single fiber. This is not typically an issue in, metro and regional networks since fiber is considered plentiful in these applications. However, as customers require increasing amounts of bandwidth in access networks between their locations, it may be difficult for a carrier to provide optical traffic capacity of 100 Gbit/s or more if only a single fiber is available.

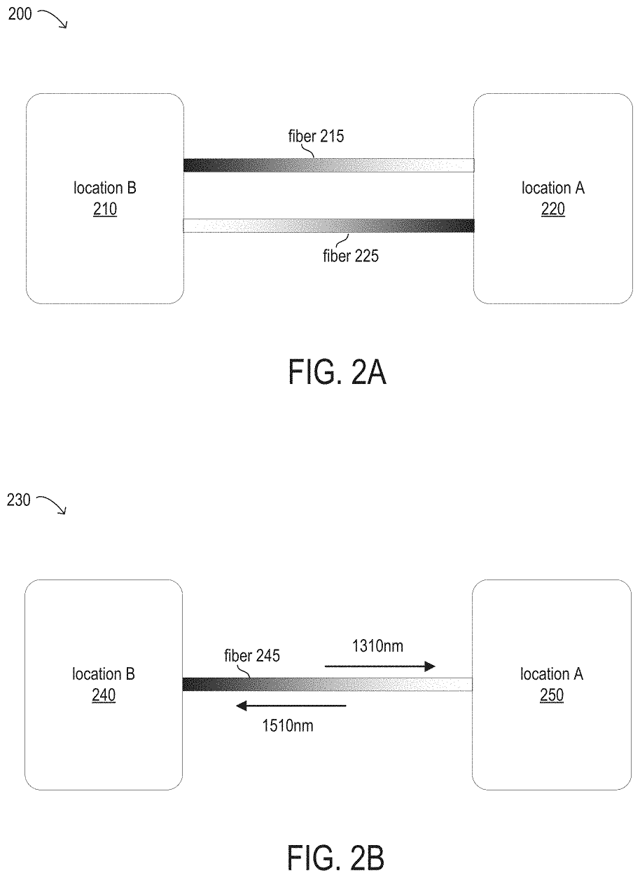

For example, FIG. 2A is a block diagram illustrating selected elements of an optical network 200 carrying bi-directional traffic over two fiber cables. Optical network 200, which may be deployed in a metro, regional, or long-haul application, uses separate fibers for the transmit and receive directions, respectively. More specifically, optical signal traffic transmitted from location A (220) to location B (210) may be carried over fiber 215, while optical signal traffic transmitted from location B (210) to location A (220) may be carried over fiber 225.

In another example, FIG. 2B is a block diagram illustrating selected elements of an optical network 230 carrying bi-directional traffic on a single fiber. Optical network 230 may, e.g., in an access network, include a single fiber that is deployed toward a customer and in which optical signal traffic in the transmit and receive directions is carried on the same fiber. For example, optical network 230 may be deployed in an industry in which high capacity optical signal traffic is exchanged between a supplier and a large customer or between a company headquarters and a data center. The services provided in each direction are single wavelength services, typically 10 Gbit/s, within different optical wavelength bands. In the illustrated example, the optical devices used to provide service on optical network 230 may use 1310 nm in one direction and 1510 nm in the reverse direction. These devices typically have relatively imprecise lasers, such that the actual wavelengths in each direction may vary by as much as 30-50 nm from the target wavelength, in some cases. This makes them unsuitable for multi-channel operation and not easily scalable for optical signal traffic at a capacity greater than 10 Gbit/s. In this example, fiber 245 carries optical signal traffic from location B (240) to location A (250) as optical signals having a target wavelength of 1310 nm and carries optical signal traffic from location A (250) to location B (240) as optical signals having a target wavelength of 1510 nm.

As will be described in further detail, systems and methods are disclosed herein for providing bi-directional single fiber transmission in optical networks using wavelength conversion. More specifically, the systems described herein may implement an approach to bi-directional transmission in which optical signal traffic is carried by optical signals in multiple channels having wavelengths in one optical wavelength band in the transmit direction and optical signal traffic is carried by optical signals in multiple channels having wavelengths in another optical wavelength band in the transmit direction. Because the underlying transponders transmit and receive optical signals in the same optical wavelength band, the systems described herein use wavelength converters at each end of a single fiber cable to convert optical signals having wavelengths in an optical wavelength band other than the one in which the transponders transmit and receive optical signals to the optical wavelength band in which the transponders transmit and receive optical signals and vice versa.

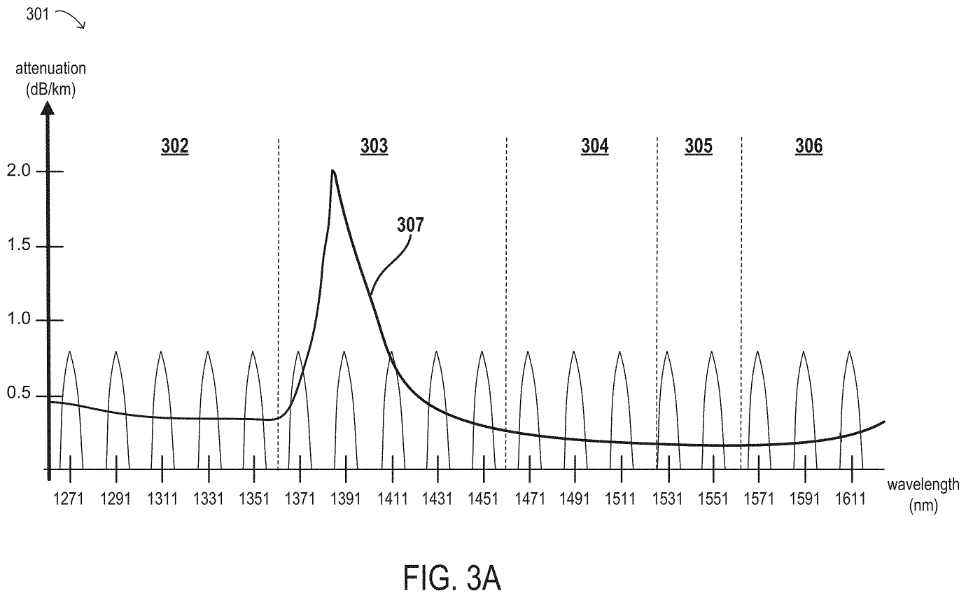

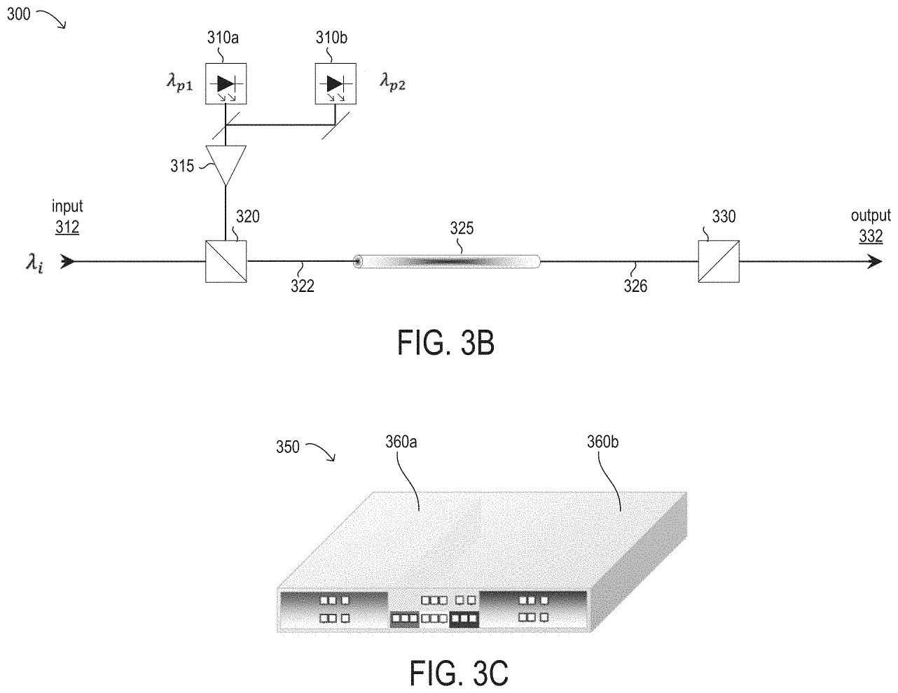

FIG. 3A is a graph 301 illustrating five optical wavelength bands defined by the International Telecommunication Union Telecommunication Standardization Sector (ITU-T) and corresponding measurements of transmission performance in terms of attenuation. These predefined optical wavelength bands include the “Short wavelength” S-Band, shown as 304, comprising wavelengths between 1460 and 1530 nanometers, the “Conventional” or “Central” C-Band, shown as 305, comprising wavelengths between 1530 and 1565 nanometers, and the “Long wavelength” L-Band, shown as 306, comprising wavelengths between 1565 and 1625 nanometers. The use of particular ones of these optical wavelength bands for telecommunication services may be more common in certain regions that in others. For example, carriers in North America typically use the C-Band to carry optical signal traffic. There are 96 50 Ghz channels in the C-Band, each corresponding to a respective wavelength between 1530 and 1565 nanometers. Each of the channels may typically operate at a data rate on the order of 100 Gbits/s, for a total of approximately 10 Terabits/s, or at a data rate of up to 200 Gbits/s, for a total of approximately 20 Terabits/s. Another commonly used optical wavelength band, e.g., in Japan, is the L-Band comprising wavelengths between 1565 and 1625 nanometers. The S-Band is also available for optical signal traffic, but it is not typically used for this purpose in existing optical networks.

The optical wavelength bands defined by the ITU-T also include additional optical wavelength bands not typically used for optical signal traffic. These include the “Original” O-Band, shown as 302, comprising wavelengths between 1260 and 1360 nanometers, and the “Extended” E-Band, shown in 303, comprising wavelengths between 1360 and 1460 nanometers. A sixth wavelength band defined by the ITU-T is the “Ultra-long wavelength” U-Band (not shown in FIG. 3A), which comprises wavelengths between 1625 and 1675 nanometers.

As shown by performance curve 307 in FIG. 3A, the performance of optical transmissions in the C-Band and in the L-Band are largely the same except that the L-Band has slightly poorer performance, i.e., slightly more attenuation, at the extreme right end of the band. The S-Band also exhibits reasonable transmission performance across the band with slightly poorer performance at the extreme left end of the band. By way of contrast, the E-Band performance exhibits a large water peak that renders it largely unusable.

FIG. 3B is a block diagram 300 illustrating selected elements of an embodiment of an optical wavelength converter. In the example embodiment illustrated in FIG. 3B, the wavelength converter includes two pump light sources 310 shown as pump light source 310a, which provides a light source having a wavelength λₚ₁ and pump light source 310b, which provides a light source having a wavelength λₚ₂. The wavelength converter also includes pump 315, polarization beam combiner 320, and a nonlinear medium 325. An input optical signal 312 having a wavelength λᵢ is combined, at polarization beam combiner 320, with the output of pump 315, resulting in the optical signal 322. Optical signal 322 then passes through nonlinear medium 325 where it is converted to an optical signal 326 in a different optical wavelength band than the input optical signal 312.

The nonlinear medium 325 may convert wavelengths within a first predefined optical wavelength band to respective wavelengths within a second predefined optical wavelength band. For example, the nonlinear medium 325 may be selected, fabricated, or configured to perform a desired wavelength conversion from a particular first one of the standard predefined optical wavelength bands (e.g., the C-Band, L-Band, or S-Band) to a particular second one of the standard predefined optical wavelength bands.

The converted optical signal 326 may be provided to polarization beam splitter 330, the output of which, shown as 332, includes two components. One component, i.e., the component of the converted signal having the shorter λ, may be represented mathematically as follows:

λ_{cs}=(λᵢ⁻¹+|λₚ₁⁻¹−λₚ₂⁻¹|)⁻¹

A second component, i.e., the component of the converted signal having the longer λ, may be represented mathematically as follows:

λ_{cl}=(λᵢ⁻¹+|λₚ₁⁻¹−λₚ₂⁻¹|)⁻¹

In other embodiments, a wavelength converter may include different components than those illustrated in FIG. 3B.

FIG. 3C illustrates an example wavelength converter device 350 configured for wavelength converted signal generation, in accordance with some embodiments. In at least some embodiments, wavelength converter device 350 may have the ability to convert a C-Band signal into either an L-Band or an S-Band signal, or vice versa, as described herein. For example, wavelength converter device 350 may include a nonlinear medium, such as nonlinear medium 325 shown in FIG. 3B, that is selected, fabricated, or configured to receive a signal in the C-Band and, essentially, create a copy of the input optical signal, including its multiple composite wavelengths, in either the L-Band or the S-Band.

As shown in the illustrated embodiment, a wavelength converter device 350 at a source location may include up to two wavelength conversion units 360, one of which is configured to convert optical signal traffic from the C-Band to the L-Band, and one of which is configured to convert optical signal traffic from the C-Band to the S-Band. A complimentary wavelength converter device at a destination location may be configured to reverse the conversion performed by wavelength converter device 350. For example, the wavelength converter device at the destination location may convert optical signal traffic from the L-Band or S-Band back to the C-Band.

Other wavelength conversions are possible, in other embodiments. In general, a wavelength converter device 350 may be configured to convert optical signal traffic between any two of the C-Band, the S-Band, and the L-Band, in different embodiments. In one embodiment, a wavelength converter device 350 may be configured to convert optical signal traffic on a primary path between source and destination locations from the L-Band to the C-Band in response to a fiber cut or other fiber failure on the primary path.

In the optical transport networks disclosed herein, an optical wavelength converter, such as wavelength converter device 350, may be used to “shift” optical signal traffic in one direction into an optical wavelength band other than the optical wavelength band on which the transponders at opposite ends of a single fiber operate. The optical signals in the two optical wavelength bands may then be merged onto the single fiber via a combiner/splitter and/or or Y-cable at each end. Using this approach, optical signal traffic in the two directions may be transmitted over a single fiber between two sites using different optical wavelength bands while, to the transponders at each end of the fiber, the transmissions appear to use only a single wavelength band, e.g., the C-Band. In some embodiments, using this approach may allow an upgrade to the capacity of an optical transport network from 10 Gbits/s to 100 Gbits/s or more, and may also allow the capacity to scale up to 96 channels in the C-Band, providing ample capacity for customers served by a private line service.

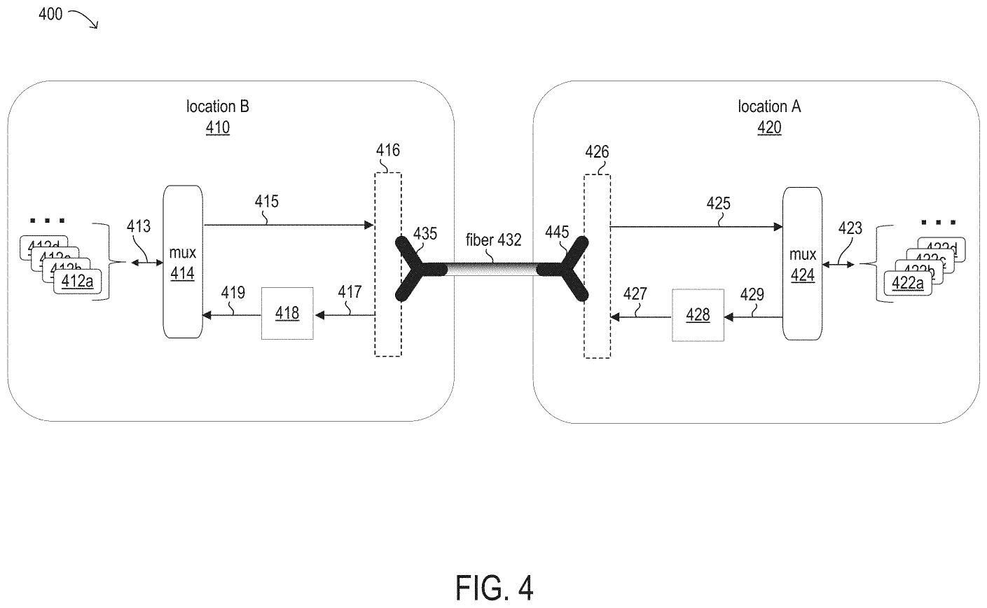

FIG. 4 is a block diagram illustrating selected elements of an optical network 400 including a single fiber cable between a pair of locations, in accordance with some embodiments. In the illustrated example, optical network 400 includes, at location A (420), multiple transponders 422 and a multiplexer 424 and, at location B (410), multiple transponders 412 and a multiplexer 414. In this example embodiment, optical signal traffic may be exchanged between the transponders 422 at location A (420) and the transponders 412 at location B (410) over a single fiber cable, shown as fiber 432. For example, each of the transponders at location A (420) and location B (410) may be configured to generate and/or receive optical signals having a respective one of the wavelengths defined within a first predefined optical wavelength band (e.g., within the C-Band) at different times. In other embodiments, there may be separate optical transmitters and receivers at each of location A (420) and location B (410) for each such wavelength. In this example, because there are 96 wavelengths defined within the C-Band, there may be 96 transponders 412 at location B (410), i.e., one transponder 412 for each wavelength within the C-Band, that collectively generate and receive optical signals for each wavelength within the C-Band. Similarly, there may be 96 transponders 422 at location A (420), i.e., one transponder 422 for each wavelength within the C-Band, that collectively generate and receive optical signals for each wavelength within the C-Band.

At location A (420), the outputs of the transponders 422 are input, at 423, to multiplexer 424 for eventual transmission to location B (410). The outputs of multiplexer 424 to be transmitted to location B (410) are shown as multiplexed optical signals 429, which contain all 96 wavelengths of the C-Band. In the illustrated example, the optical signals 429 are provided to an optical wavelength converter 428, which is configured to convert optical signals having wavelengths within C-Band to optical signals having wavelengths within another predefined optical wavelength band, such as the L-Band, prior to transmission to location B (410) over fiber 432.

At location B (410), the outputs of the transponders 412 are input, at 413, to multiplexer 414. The outputs of multiplexer 414 to be transmitted to location A (420) are shown as optical signal traffic 415, which contains all 96 wavelengths of the C-Band. In this example, optical signal traffic 415 is routed to Y-cable 435 without optical wavelength conversion.

Note that, while a wavelength converter device such as wavelength converter device 350 illustrated in FIG. 3C may include multiple optical wavelength converters for symmetric conversion of bi-directional traffic at opposite ends of a fiber cable, the optical networks described herein may perform asymmetric wavelength conversion in which wavelength conversion is applied only to the optical signal traffic in one direction. Therefore, at each location, a single optical wavelength converter is configured to convert the optical signal traffic only in that one direction. For example, optical wavelength converter 428 residing at location A (420) and optical wavelength converter 418 residing at location B (410) are both used to convert optical signal traffic transmitted from location A (420) to location B (410). More specifically, optical wavelength converter 428 may include a nonlinear medium that converts all wavelengths within the C-Band to respective wavelengths within the L-Band, such that optical wavelength converter 428 is configured to convert optical signals 429 having wavelengths in the C-Band to converted optical signals 427 having wavelengths in the L-Band for transmission over fiber 432. Subsequently, optical wavelength converter 418 is configured to convert the optical signals of optical signal traffic 417 received over fiber 432 and having wavelengths in the L-Band to optical signals 419 having wavelengths in the C-Band. For example, optical wavelength converter 418 may include a nonlinear medium that converts all wavelengths within the L-Band to respective wavelengths within the C-Band. In this example, optical signal traffic 417 received at location B (410) corresponds to optical signals 427 transmitted from location A (420). In the illustrated example, optical signal traffic transmitted from location B (410) to location A (420) is shown as optical signal traffic 415, which includes optical signals having wavelengths in the C-Band, while optical signal traffic transmitted from location A (420) to location B (410) is shown as optical signal traffic 417, which includes optical signals having wavelengths in the L-Band.

As shown in FIG. 4, optical network 400 may, optionally, include a band combiner/splitter at each end of fiber 432. These are shown as optional band combiner/splitter 416, which resides at location B (410), and optional band combiner/splitter 426, which resides at location A (420). In the illustrated example, optional band combiner/splitter 416 is coupled to Y-cable 435, which is configured to merge optical signal traffic 415, including optical signals having wavelengths in the C-Band, onto fiber 432 for transmission from location B (410) to location A (420) while fiber 432 also carries optical signals 427, having wavelengths in the L-Band, from location A (420) to location B (410). In embodiments that do not include optional band combiner/splitter 416, optical signal traffic 415 may be provided directly to Y-cable 435 for merging onto fiber 432. Similarly, optional band combiner/splitter 426 is coupled to Y-cable 445, which is configured to merge optical signals 427, having wavelengths in the L-Band, onto fiber 432 for transmission from location A (420) to location B (410) while fiber 432 also carries optical signal traffic 415, which includes optical signals having wavelengths in the C-Band, from location B (410) to location A (420). In embodiments that do not include optional band combiner/splitter 426, optical signals 427 may be provided directly to Y-cable 445 for merging onto fiber 432.

In the illustrated example, optional band combiner/splitter 416 and/or Y-cable 435 are also configured to split out optical signal traffic 417, which includes optical signals having wavelengths in the L-Band, as received over fiber 432, and route optical signal traffic 417 to optical wavelength converter 418 for conversion to optical signals 419 having wavelengths in the C-Band. Optical signals 419 are then provided to transponders 412 through multiplexer 414. More specifically, multiplexer 414 demultiplexes optical signals 419 into the 96 wavelengths of the C-Band, each of which is provided to a respective one of the 96 transponders 412. In embodiments that do not include optional band combiner/splitter 416, optical signal traffic 417 may be provided directly to optical wavelength generator 418 by Y-cable 435. In the illustrated embodiment, optional band combiner/splitter 426 and/or Y-cable 445 are also configured to split out optical signal traffic 425, which includes optical signals having wavelengths in the C-Band, as received over fiber 432, and to route optical signal traffic 425 to multiplexer 424 without optical wavelength conversion. In this example, optical signal traffic 425 received at location A (420) corresponds to optical signal traffic 415 transmitted from location B (410). In embodiments that do not include optional band combiner/splitter 426, optical signal traffic 425 may be provided directly to multiplexer 424 by Y-cable 445.

While in the example embodiment illustrated in FIG. 4, the transponders 412 and 422 at locations B (410) and A (420), respectively, generate and receive optical signals having wavelengths in the C-Band, in other embodiments, the transponders may generate and receive optical signals having wavelengths in a different predefined optical wavelength band, such as the L-Band or the S-Band. In these alternate embodiments, an optical wavelength converter at a first location may be configured to convert optical signals having wavelengths in the L-band, as generated by the transponders at the first location, to optical signals having wavelengths in the C-Band or the S-Band for transmission to a second location. An optical wavelength converter at the second location may be configured to convert the optical signals received from the first location to optical signals having wavelengths in the L-band and to provide them to the transponders at the second location. In these alternate embodiments, optical signal traffic may be transmitted from the second location to the first location as optical signals having wavelengths in the L-band, i.e., without optical wavelength conversion.

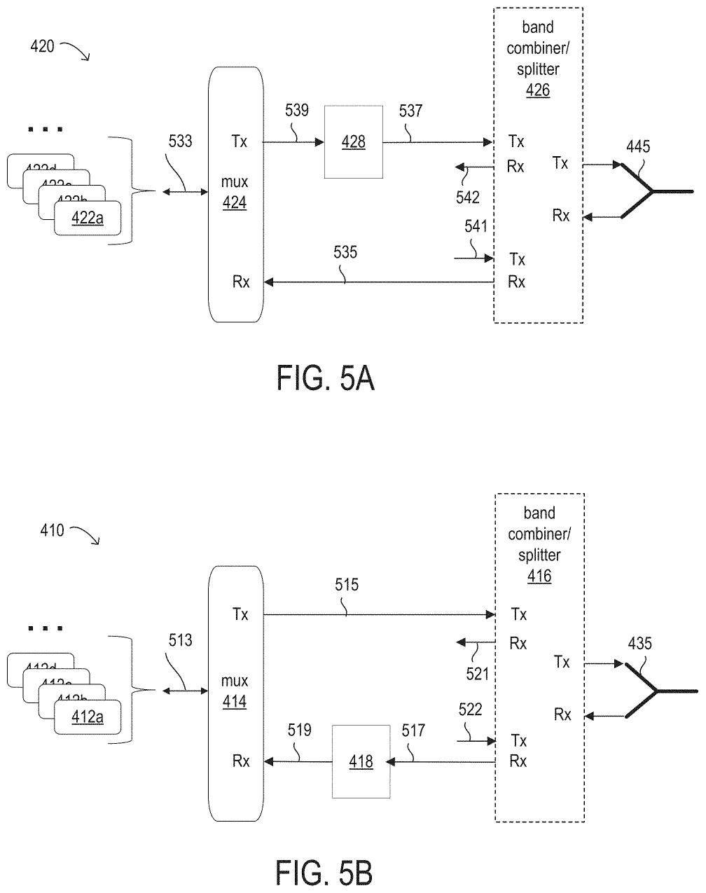

FIG. 5A is a block diagram illustrating a wiring diagram for selected elements of an optical network at a first location, in accordance with some embodiments. For example, the optical network may be similar to optical network 400 illustrated in FIG. 4 and the illustrated elements may be similar to elements at location A (420). In the illustrated example, transponders 422 are coupled to multiplexer 424 over bi-directional connection 533, a transmit port of multiplexer 424 is coupled to optical wavelength converter 428 over connection 539, optical wavelength converter 428 is coupled to a transmit port in a first transmit/receive port pair of optional band combiner/splitter 426 over connection 537, and a receive port in a second transmit/receive port pair of optional band combiner/splitter 426 is coupled to a receive port of multiplexer 424 over connection 535.

As illustrated in this example, optical wavelength conversion is applied only to optical signal traffic going in one direction, in this case to optical signal traffic transmitted from location A (420). Therefore, half of the client-side ports on optional band combiner/splitter 426 are unused. In this case, the receive port in the first transmit/receive port pair of optional band combiner/splitter 426 is unused and thus unconnected, as shown at 542. In addition, the transmit port in the second transmit/receive port pair of optional band combiner/splitter 426 is unused and thus unconnected, as shown at 541. A third transmit/receive port pair of optional band combiner/splitter 426 is configured for bi-directional network traffic over Y-cable 445, which merges the bi-directional traffic for transmission over fiber 432 (not shown in FIG. 5A). In embodiments that do not include optional band combiner/splitter 426, connection 537 may be coupled directly to Y-cable 445 and Y-cable 445 may also be coupled directly to connection 535.

FIG. 5B is a block diagram illustrating a wiring diagram for selected elements of an optical network at a second location, in accordance with some embodiments. For example, the optical network may be similar to optical network 400 illustrated in FIG. 4 and the illustrated elements may be similar to elements at location B (410). In the illustrated example, transponders 412 are coupled to multiplexer 414 over bi-directional connection 513, a transmit port of multiplexer 414 is coupled to a transmit port in a first transmit/receive port pair of optional band combiner/splitter 416 over connection 515, a receive port in a second transmit/receive port pair of optional band combiner/splitter 416 is coupled to optical wavelength converter 418 over connection 517, and optical wavelength converter 418 is coupled to a receive port of multiplexer 414 over connection 519.

As illustrated in this example, optical wavelength conversion is applied only to optical signal traffic going in one direction, in this case to optical signal traffic received at location B (410). Therefore, half of the client-side ports on optional band combiner/splitter 416 are unused. In this case, the receive port in the first transmit/receive port pair of optional band combiner/splitter 416 is unused and thus unconnected, as shown at 521. In addition, the transmit port in the second transmit/receive port pair of optional band combiner/splitter 416 is unused and thus unconnected, as shown at 522. A third transmit/receive port pair of optional band combiner/splitter 416 is configured for bi-directional network traffic, such as over fiber 432 (not shown in FIG. 5A), over connections 525. In embodiments that do not include optional band combiner/splitter 416, connection 515 may be coupled directly to Y-cable 435 and Y-cable 435 may also be coupled directly to connect 517.

In at least some embodiments, including in the embodiments illustrated in FIGS. 4, 5A, and 5B, all of the components shown as residing at location B (410), including transponders 412, multiplexer 414, optical wavelength converter 418, optional band combiner/splitter 416, and Y-cable 435 may be physically co-located within a central physical location that is both a source and destination for optical signal traffic between location B (410) and location A (420) over the single fiber 432. Similarly, all of the components shown as residing at location A (420), including transponders 422, multiplexer 424, optical wavelength converter 428, optional band combiner/splitter 426, and Y-cable 445 may be physically co-located within a central physical location that is both a source and destination for optical signal traffic between location A (420) and location B (410) over the single fiber 432.

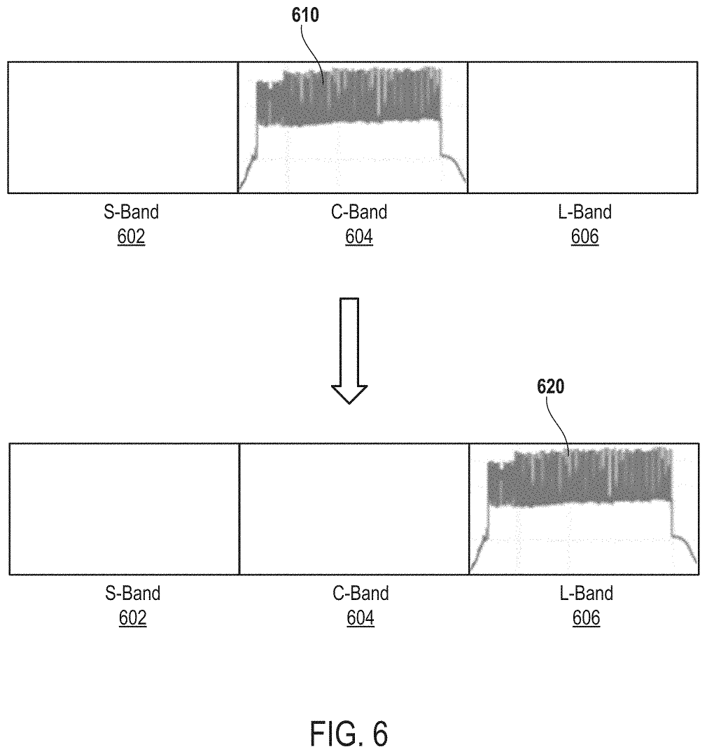

FIG. 6 illustrates an example wavelength conversion, in accordance with some embodiments. In this example, prior to the optical signal traffic 610 passing through a wavelength converter, there is no activity in the S-Band, shown as 602, and no activity in the L-Band, shown as 606. Optical signal traffic 610 represents a multiplexed collection of optical signals each generated by a corresponding transponder and each having a respective wavelength within the C-Band. More specifically, optical signal traffic 610 includes up to 96 discrete 50 Ghz wavelengths that form a spectrum pattern. In this example, optical signal traffic 610 passes through the wavelength converter, as represented in FIG. 6 by the downward arrow, thus creating an exact copy of the spectrum pattern formed by the input optical signal traffic 610, shown as optical signal traffic 620, which has been moved to the L-Band. More specifically, in the illustrated example, optical signal traffic 620 includes the same number of optical signals as optical signal traffic 610, but each of the optical signals in optical signal traffic 620 has a wavelength within the L-Band rather than a wavelength within the C-Band. In the illustrated example, subsequent to the optical signal traffic 610 passing through the wavelength converter, there is no activity in the S-Band, shown as 602, and no activity in the C-Band, shown as 604.

While several example embodiments are described herein in which optical signal traffic comprising optical signals having wavelengths within the C-Band is converted to optical signal traffic comprising optical signals having wavelengths within the L-Band, other wavelength conversions are possible, in other embodiments. In general, a wavelength converter device such as those described herein may be configured to convert optical signal traffic between any two of the C-Band, the S-Band, and the L-Band, in different embodiments.

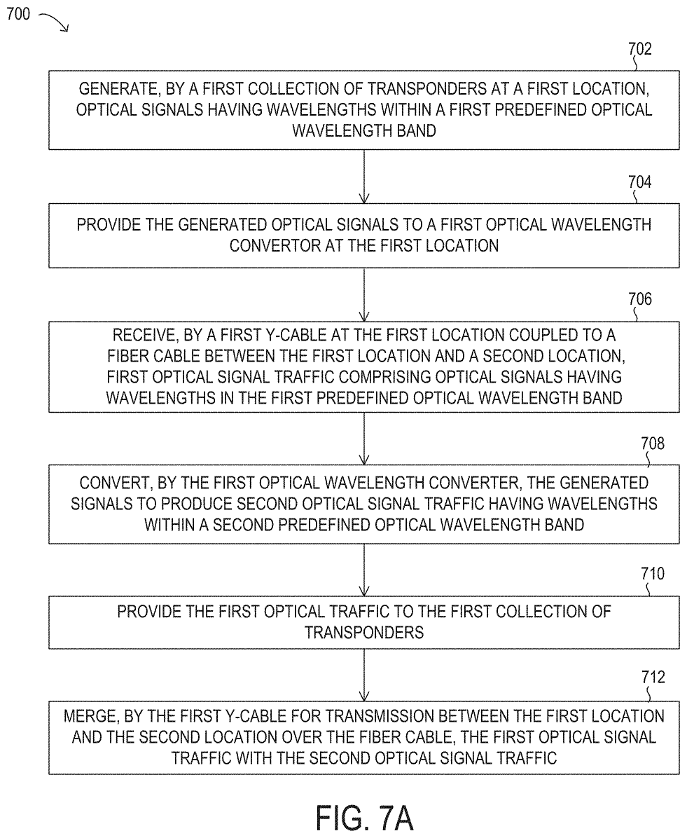

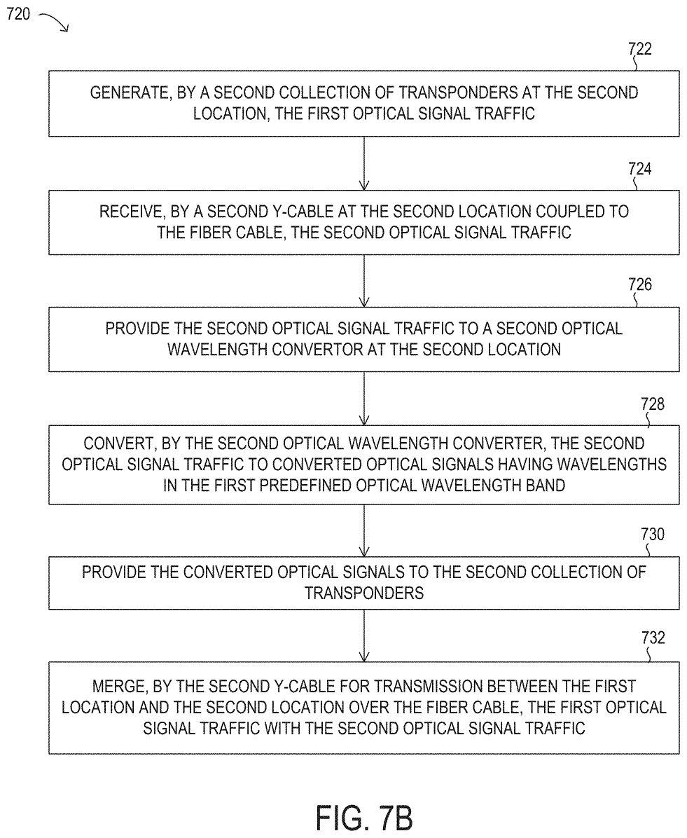

Referring now to FIG. 7A, a block diagram of selected elements of an embodiment of a method 700 for providing bi-directional single fiber transmission in optical networks using wavelength conversion, as described herein, is depicted in flowchart form. In particular, FIG. 7A illustrates selected elements of a method 700 for providing bi-directional single fiber transmission from the perspective of components at a first location, such as location A (420) illustrated in FIGS. 4 and 5A, when exchanging optical signal traffic between the first location and a second location, such as location B (410) illustrated in FIGS. 4 and 5B, over a single fiber, such as fiber 432. In various embodiments, some or all of the operations of method 700 depicted in FIG. 7 may be performed by components of an optical network including, but not limited to, any of the components illustrated in FIG. 1, 3B, 3C, 4, 5A, or 5B. It is noted that certain operations described in method 700 may be optional or may be rearranged in different embodiments.

Method 700 may begin, at 702, with generating, by a first collection of transponders at a first location, optical signals having wavelengths within a first one of multiple predefined optical wavelength bands supported in the optical network. For example, the optical signals may have wavelengths within the C-Band (e.g., between 1530 and 1565 nanometers). In at least some embodiments, multiple ones of the generated optical signals having wavelengths within the first predefined optical wavelength band may be combined into a wideband optical signal using wavelength division multiplexing for transmission in respective channels. For example, the wideband optical signal may include all 96 wavelengths in the C-Band.

At 704, method 700 may include providing the generated optical signals to a first optical wavelength convertor at the first location. The first optical wavelength converter may be configured to convert optical signals having wavelengths within the first predefined optical wavelength band to optical signals having wavelengths within a second one of the multiple predefined optical wavelength bands. For example, the first optical wavelength converter may be configured to convert optical signals having wavelengths within the C-Band to optical signals having wavelengths within the L-Band.

At 706, the method may include receiving, by a first Y-cable at the first location coupled to a fiber cable between the first location and a second location, first optical signal traffic comprising optical signals having wavelengths in the first predefined optical wavelength band.

At 708, method 700 may include converting, by the first optical wavelength converter, the generated signals to produce second optical signal traffic having wavelengths within the second predefined optical wavelength band, e.g., the L-Band.

At 710, the method may include providing the first optical traffic to the first collection of transponders.

At 712, the method may include merging, by the first Y-cable for transmission between the first location and the second location over the fiber cable, the first optical signal traffic with the second optical signal traffic. For example, the first optical signal traffic may be received at the first location from the second location, and the second optical signal traffic may be transmitted from the first location to the second location.

Referring now to FIG. 7B, a block diagram of selected elements of an embodiment of a method 720 for providing bi-directional single fiber transmission in optical networks using wavelength conversion, as described herein, is depicted in flowchart form. In particular, FIG. 7B illustrates selected elements of a method 720 for providing bi-directional single fiber transmission from the perspective of components at a second location, such as location B (410) illustrated in FIGS. 4 and 5B, when exchanging optical signal traffic between the second location and the first location, such as location A (420) illustrated in FIGS. 4 and 5A, over a single fiber, such as fiber 432. In various embodiments, some or all of the operations of method 720 depicted in FIG. 7B may be performed by components of an optical network including, but not limited to, any of the components illustrated in FIG. 1, 3B, 3C, 4, 5A, or 5B. It is noted that certain operations described in method 720 may be optional or may be rearranged in different embodiments.

Method 720 may begin, at 722, with generating, by a second collection of transponders at the second location, the first optical signal traffic. For example, the first optical signal traffic may include optical signals having wavelengths within the C-Band (e.g., between 1530 and 1565 nanometers). In at least some embodiments, the first optical signal traffic may include multiple ones of the generated optical signals having wavelengths within the first predefined optical wavelength band that are combined into a wideband optical signal using wavelength division multiplexing for transmission in respective channels. For example, the wideband optical signal may include all 96 wavelengths in the C-Band.

At 724, method 720 may include receiving, by a second Y-cable at the second location coupled to the fiber cable, the second optical signal traffic comprising optical signals having wavelengths in the second predefined optical wavelength band.

At 726, the method may include providing the second optical signal traffic to a second optical wavelength convertor at the second location. The second optical wavelength converter may be configured to convert optical signals having wavelengths within the second predefined optical wavelength band to optical signals having wavelengths within the first predefined optical wavelength band. For example, the second optical wavelength converter may be configured to convert optical signals having wavelengths within the L-Band to optical signals having wavelengths within the C-Band.

At 728, method 720 may include converting, by the second optical wavelength converter, the second optical signal traffic to converted optical signals having wavelengths in the first predefined optical wavelength band, e.g., the C-Band.

At 730, the method may include providing the converted optical signals to the second collection of transponders.

At 732, the method may include merging, by the second Y-cable for transmission between the first location and the second location over the fiber cable, the first optical signal traffic with the second optical signal traffic. For example, the first optical signal traffic may be transmitted from the second location to the first location, and the second optical signal traffic may be received at the second location from the first location.

While FIGS. 7A and 7B illustrate an example embodiment in which the first predefined optical wavelength band is the C-Band and the second predefined optical wavelength band is the L-Band, in other embodiments, one or more of the first and second predefined optical wavelength bands may be different from the predefined optical wavelength bands in this example embodiment. In general, the multiple predefined optical wavelength bands may include two or more of: the C-Band, comprising wavelengths between 1530 and 1565 nanometers, the L-Band, comprising wavelengths between 1565 and 1625 nanometers, and the S-Band, comprising wavelengths between 1460 and 1530 nanometers, in various embodiments.

The optical networks described herein may include wavelength converters to convert optical signal traffic from one predefined optical wavelength band to another, along with associated band combiners, to provide bi-directional single fiber transmission. The techniques described herein may be used to provide bi-directional single fiber transmission in optical networks for the entire payload, e.g., all 96 wavelengths in the C-Band, rather than only for individual wavelengths. In at least some embodiments, the advantages of the disclosed approach may include providing greatly increased transmission capacity, when compared to existing single fiber transmission schemes, without the need to upgrade or duplicate the existing fiber cable.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A system for bi-directional single fiber transmission using wavelength conversion, comprising:
a fiber cable between a first location and a second location;
a first optical wavelength converter at the first location configured to convert optical signals having wavelengths within a first one of multiple predefined optical wavelength bands to optical signals having wavelengths within a second one of the multiple predefined optical wavelength bands;
a first Y-cable at the first location coupled to the fiber cable and configured to merge first optical signal traffic comprising optical signals in the first predefined optical wavelength band with second optical signal traffic comprising optical signals in the second predefined optical wavelength band for transmission between the first location and the second location over the fiber cable, the first optical signal traffic transmitted along a first direction and being received at the first location from the second location, the second optical signal traffic being transmitted along a second direction and from the first location to the second location, the second direction opposite to the first direction, asymmetric wavelength conversion is provided by at least the first optical wavelength converter such that merged first optical signal traffic and the second optical signal traffic is communicated over the fiber cable;
a first collection of transponders at the first location configured to:
generate optical signals in the first predefined optical wavelength band;
route the generated optical signals to the first optical wavelength convertor to produce the second optical signal traffic comprising the optical signals in the second predefined optical wavelength for transmission to the second location over the fiber cable;
receive the optical signals of the first optical signal traffic;
a second collection of transponders at the second location configured to:
generate optical signals in the first predefined optical wavelength band for transmission to the first location over the fiber cable; and
receive converted optical signals representing the second optical signal traffic, the converted optical signals in the first predefined optical wavelength band.

2. The system of claim 1, wherein:
the first optical signal traffic comprises a first wideband optical signal in which multiple optical signals having wavelengths within the first predefined optical wavelength band are combined using wavelength division multiplexing for transmission over the fiber cable in respective channels; and
the second optical signal traffic comprises a second wideband optical signal in which multiple optical signals having wavelengths within the second predefined optical wavelength band are combined using wavelength division multiplexing for transmission over the fiber cable in respective channels.

3. The system of claim 1, wherein each transponder in the first collection of transponders is configured to generate and receive optical signals having a respective one of the wavelengths within the first predefined optical wavelength band.

4. The system of claim 1, wherein the first optical wavelength converter comprises a nonlinear medium that converts all wavelengths within the first predefined optical wavelength band to respective wavelengths within the second predefined optical wavelength band.

5. The system of claim 1, further comprising:
a second optical wavelength converter at the second location configured to convert optical signals having wavelengths within the second predefined optical wavelength band to optical signals having wavelengths within the first predefined optical wavelength band;
a second Y-cable at the second location coupled to the fiber cable and configured to:
merge the first optical signal traffic comprising optical signals in the first predefined optical wavelength band with the second optical signal traffic comprising optical signals in the second predefined optical wavelength band for transmission between the first location and the second location over the fiber cable, the first optical signal traffic being transmitted from the second location to the first location, the second optical signal traffic being received at the second location from the first location; and
route the second optical signal traffic to the second optical wavelength convertor to produce the converted optical signals representing the second optical signal traffic.

6. The system of claim 5, wherein each transponder in the second collection of transponders is configured to generate and receive optical signals having a respective one of the wavelengths within the first predefined optical wavelength band.

7. The system of claim 5, wherein the second optical wavelength converter comprises a nonlinear medium that converts all wavelengths within the second predefined optical wavelength band to respective wavelengths within the first predefined optical wavelength band.

8. The system of claim 1, wherein the multiple predefined optical wavelength bands comprise two or more of:
the C-Band, comprising wavelengths between 1530 and 1565 nanometers;
the L-Band, comprising wavelengths between 1565 and 1625 nanometers; and
the S-Band, comprising wavelengths between 1460 and 1530 nanometers.

9. The system of claim 8, wherein:
the first optical signal traffic comprises optical signals having wavelengths within the C-Band; and
the second optical signal traffic comprises optical signals having wavelengths within the L-Band or within the S-Band.

10. The system of claim 8, wherein:
the first optical signal traffic comprises optical signals having wavelengths within the L-Band; and
the second optical signal traffic comprises optical signals having wavelengths within the C-Band.

11. A method for transmitting bi-directional optical signal traffic over a single fiber, comprising:
generating, by a first collection of transponders at a first location, optical signals having wavelengths within a first one of multiple predefined optical wavelength bands;
providing the generated optical signals to a first optical wavelength convertor at the first location, the first optical wavelength converter configured to convert optical signals having wavelengths within the first predefined optical wavelength band to optical signals having wavelengths within a second one of the multiple predefined optical wavelength bands;
receiving, by a first Y-cable at the first location coupled to a fiber cable between the first location and a second location, first optical signal traffic comprising optical signals in the first predefined optical wavelength band;
converting, by the first optical wavelength converter, the generated signals to produce second optical signal traffic having wavelengths within the second predefined optical wavelength band;
providing the first optical traffic to the first collection of transponders;
merging, by the first Y-cable for transmission between the first location and the second location over the fiber cable, the first optical signal traffic and the second optical signal traffic, the first optical signal traffic transmitted along a first direction and being received at the first location from the second location, the second optical signal traffic being transmitted along a second direction and from the first location to the second location, the second direction opposite to the first direction, asymmetric wavelength conversion is provided by at least the first optical wavelength converter such that merged first optical signal traffic and the second optical signal traffic is communicated over the fiber cable;
generating, by a second collection of transponders at the second location, optical signals in the first predefined optical wavelength band for transmission to the first location over the fiber cable; and
receiving, by the second collection of transponders at the second location, converted optical signals representing the second optical signal traffic, the converted optical signals in the first predefined optical wavelength band.

12. The method of claim 11, further comprising:
combining, at the second location using wavelength division multiplexing, multiple optical signals having wavelengths within the first predefined optical wavelength band to generate the first optical signal traffic;
transmitting the first optical signal traffic from the second location to the first location in respective optical channels over the fiber cable;
combining, at the first location using wavelength division multiplexing, multiple optical signals having wavelengths within the second predefined optical wavelength band to generate the second optical signal traffic; and
transmitting the second optical signal traffic from the first location to the second location in respective optical channels over the fiber cable.

13. The method of claim 11, wherein each transponder in the first collection of transponders generates and receives optical signals having a respective one of the wavelengths within the first predefined optical wavelength band.

14. The method of claim 11, wherein the first optical wavelength converter comprises a nonlinear medium that converts all wavelengths within the first predefined optical wavelength band to respective wavelengths within the second predefined optical wavelength band.

15. The method of claim 11, further comprising:
providing the second optical signal traffic to a second optical wavelength convertor at the second location, the second optical wavelength converter configured to convert optical signals having wavelengths within the second predefined optical wavelength band to optical signals having wavelengths within the first predefined optical wavelength band;
converting, by the second optical wavelength converter, the second optical signal traffic to converted optical signals having wavelengths in the first predefined optical wavelength band;
providing the converted optical signals to the second collection of transponders; and
merging, by the second Y-cable for transmission between the first location and the second location over the fiber cable, the first optical signal traffic and the second optical signal traffic, the first optical signal traffic being transmitted from the second location to the first location, the second optical signal traffic being received at the second location from the first location.

16. The method of claim 15, wherein each transponder in the second collection of transponders is configured to generate and receive optical signals having a respective one of the wavelengths within the first predefined optical wavelength band.

17. The method of claim 15, wherein the second optical wavelength converter comprises a nonlinear medium that converts all wavelengths within the second predefined optical wavelength band to respective wavelengths within the first predefined optical wavelength band.

18. The method of claim 15, wherein the multiple predefined optical wavelength bands comprise two or more of:
the C-Band, comprising wavelengths between 1530 and 1565 nanometers;
the L-Band, comprising wavelengths between 1565 and 1625 nanometers; and
the S-Band, comprising wavelengths between 1460 and 1530 nanometers.

19. The method of claim 18, wherein:
the first optical signal traffic comprises optical signals having wavelengths within the C-Band; and
the second optical signal traffic comprises optical signals having wavelengths within the L-Band or within the S-Band.

20. The method of claim 18, wherein:
the first optical signal traffic comprises optical signals having wavelengths within the L-Band; and
the second optical signal traffic comprises optical signals having wavelengths within the C-Band.
